(19) United States
(12) Patent Application Publication
(10) Pub. No.: US 2021/0153200 A1
(43) Pub. Date: May 20, 2021

(54) COMMUNICATION METHOD AND APPARATUSES PERFORMING THE SAME

(71) Applicant: ELECTRONICS AND TELECOMMUNICATIONS RESEARCH INSTITUTE, Deajeon (KR)

(72) Inventors: Heon Kook KWON, Daejeon (KR); Kwang Seon KIM, Sejong-si (KR); Jung Nam LEE, Sejong-si (KR); JAE HO JUNG, Daejeon (KR); Young Kyun CHO, Daejeon (KR)

(21) Appl. No.: 17/082,429

(22) Filed: Oct. 28, 2020

(30) Foreign Application Priority Data
Nov. 14, 2019 (KR) 10-2019-0145720

(51) Int. Cl. H04W 72/04; H04L 27/26

(52) U.S. Cl. CPC H04W 72/0453; H04L 27/2601

(57) ABSTRACT

A communication method and apparatuses performing the same. The communication method includes arranging first subcarriers of a first frequency domain and second subcarriers of a second frequency domain based on a mirror point and performing communication based on an orthogonal frequency-division multiplexing (OFDM) communication scheme using at least one of the first subcarriers and the second subcarriers.

### CROSS-REFERENCE TO RELATED APPLICATION(S)

This application claims the benefit of Korean Patent Application No. 10-2019-0145720, filed on Nov. 14, 2019, in the Korean Intellectual Property Office, the disclosure of which is incorporated herein by reference.

### BACKGROUND

### 1. Field of the Invention

Example embodiments relate to a communication method and apparatuses performing the same.

### 2. Description of Related Art

A typical mobile communication system employs an orthogonal frequency division multiplexing (OFDM) modulation scheme. For example, both long term evolution (LTE) and 5G new radio (NR) adopt the OFDM modulation scheme. Specifically, the 5G NR may support up to a maximum unit bandwidth of 400 megahertz (MHz) and may be extended to a larger bandwidth through carrier aggregation.

In a terahertz (THz) frequency band of 100 gigahertz (GHz) or higher, which is considered as a next-generation communication after 5G, it is possible to use more abundant frequency resources than that of a frequency band used in a typical mobile communication. In the THz frequency band, more frequency resources may be used.

Recently, a mobile communication system requiring a wider bandwidth of several GHz or more has been considered. Thus, research on a mobile communication system with a wider bandwidth than the typical mobile communication system is being conducted.

A mobile communication system may have an issue of an in-phase/quadrature-phase (I/Q) imbalance characteristic. The I/Q imbalance characteristic may be the most representative of analog damage factors that affect performance during frequency conversion in broadband communication. The I/Q imbalance characteristic may be a characteristic that affects performance in a receiver and/or transmitter structure. The receiver may convert an orthogonally modulated radio frequency (RF) signal into a baseband in-phase (I) and a quadrature-phase (Q). The transmitter may convert the baseband in-phase and the quadrature-phase into an RF signal.

The mobile communication system may be implemented as a completed system only when the baseband in-phase and the quadrature-phase have the same magnitude and an accurate 90-degree phase difference.

However, typical orthogonal modulators and demodulators may have a certain amount of I/Q imbalance, that is, I/Q magnitudes and phase errors.

Also, since the I/Q imbalance error varies based on a frequency, it is difficult to compensate for the deviation in a broadband system of 100 MHz or higher.

Recently, various methods and apparatus for removing the I/Q imbalance error have been introduced to prevent the degradation in performances of the orthogonal modulator and demodulator due to the I/Q imbalance error.

However, the methods and apparatuses for removing the I/Q imbalance error may apply to a typical communication system having a bandwidth less than 100 MHz, but not apply to a wider bandwidth, for example, a bandwidth of at least 100 MHz and up to several GHz.

### SUMMARY

An aspect provides technology for performing communication based on an orthogonal frequency division multiplexing (OFDM) communication scheme using a plurality of subcarriers of a frequency domain among a plurality of subcarriers arranged asymmetrically or a plurality of subcarriers arranged symmetrically.

According to an aspect, there is provided a communication method including arranging first subcarriers of a first frequency domain and second subcarriers of a second frequency domain based on a mirror point and performing communication based on an orthogonal frequency-division multiplexing (OFDM) communication scheme using at least one of the first subcarriers and the second subcarriers.

The mirror point may be a point that divides the first frequency domain and the second frequency domain and has a frequency of zero.

The first frequency domain and the second frequency domain may be different frequency domains and correspond to each other based on the mirror point.

The first frequency domain may be an entire domain of a positive frequency, and the second frequency domain may be an entire domain of a negative frequency.

The arranging may include asymmetrically arranging the first subcarriers and the second subcarriers based on the mirror point.

The asymmetrically arranging may include arranging the first subcarriers in the first frequency domain at a first frequency interval and arranging the second subcarriers in the second frequency domain based on positions of the first subcarriers such that the second subcarriers do not correspond to the first subcarriers.

The performing may include performing the communication using the first subcarriers and the second subcarriers when the first subcarriers and the second subcarriers are arranged asymmetrically.

The performing may include performing the communication using the first subcarriers or the second subcarriers when the first subcarriers and the second subcarriers are arranged symmetrically.

According to another aspect, there is also provided a communication apparatus including a memory comprising instructions and a processor configured to execute the instructions, wherein the processor is configured to arrange first subcarriers of a first frequency domain and second subcarriers of a second frequency domain based on a mirror point and perform communication based on an orthogonal frequency-division multiplexing (OFDM) communication scheme using at least one of the first subcarriers and the second subcarriers.

The mirror point may be a point that divides the first frequency domain and the second frequency domain and has a frequency of zero.

The first frequency domain and the second frequency domain may be different frequency domains and correspond to each other based on the mirror point.

The first frequency domain may be an entire domain of a positive frequency, and the second frequency domain may be an entire domain of a negative frequency.

The processor may be configured to asymmetrically arrange the first subcarriers and the second subcarriers based on the mirror point.

The processor may be configured to arrange the first subcarriers in the first frequency domain at a first frequency interval and arrange the second subcarriers in the second frequency domain based on positions of the first subcarriers such that the second subcarriers do not correspond to the first subcarriers.

The processor may be configured to perform the communication using the first subcarriers and the second subcarriers when the first subcarriers and the second subcarriers are arranged asymmetrically.

The processor may be configured to perform the communication using the first subcarriers or the second subcarriers when the first subcarriers and the second subcarriers are arranged symmetrically.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example for explaining a typical orthogonal frequency-division multiplexing (OFDM) signal;

FIG. 2A illustrates an example for explaining an IQ imbalance of a typical OFDM signal;

FIG. 2B illustrates another example for explaining an IQ imbalance of a typical OFDM signal;

FIG. 3 is a block diagram illustrating a communication system according to an example embodiment;

FIG. 4 is a block diagram illustrating a communication apparatus of FIG. 3;

FIG. 5A illustrates an example for explaining an OFDM signal of an asymmetric structure;

FIG. 5B illustrates another example for explaining an OFDM signal of an asymmetric structure;

FIG. 6 illustrates a standard of a typical OFDM signal and a standard of an OFDM signal of an asymmetric structure;

FIG. 7A illustrates a constellation of a typical OFDM signal based on the standard of FIG. 6;

FIG. 7B illustrates a constellation of an OFDM signal of an asymmetric structure based on the standard of FIG. 6; and

FIG. 8 is a flowchart illustrating an operation of the communication apparatus of FIG. 3.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

In the present disclosure, the term “module” may refer to hardware that performs a function and an operation for each name explained in the specification, a computer program code that performs predetermined function and operation, or an electronic recordable medium, for example, a processor and a microprocessor, including a computer program code for performing predetermined function and operation.

Accordingly, the module may indicate a functional and/or structural combination of hardware for performing technical ideas of the present disclosure and/or software for driving the hardware.

Hereinafter, example embodiments will be described in detail with reference to the accompanying drawings. It should be understood, however, that there is no intent to limit this disclosure to the particular example embodiments disclosed. Like numbers refer to like elements throughout the description of the figures.

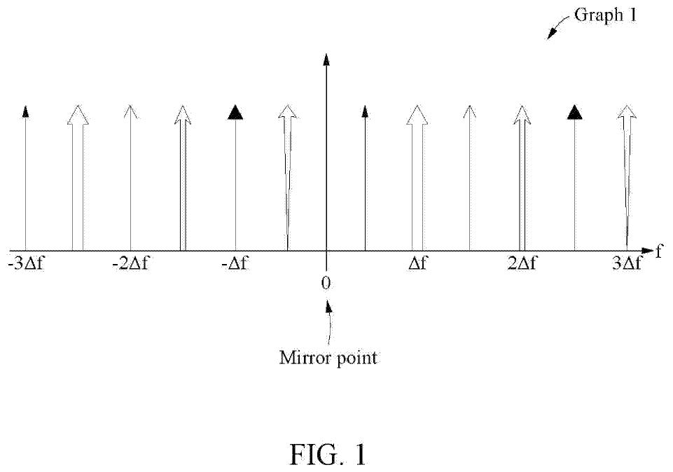

FIG. 1 illustrates an example for explaining a typical orthogonal frequency-division multiplexing (OFDM) signal.

A typical OFDM signal may be a modulated signal into which a data signal is modulated to transmit data.

The typical OFDM signal may be represented using Equation 1.

$$s ( t ) = {\sum }_{k = - \frac{{N}_{s}}{2}}^{\frac{{N}_{s}}{2} - 1} {d}_{k + \frac{{N}_{s}}{2}} \cdot exp ( j 2 π \cdot k Δ f \cdot t ) \qquad [ Equation 1 ]$$

In Equation 1, s(t) denotes an OFDM signal, dₖ denotes a symbol of a modulated signal which is data to be transmitted, N_{S} denotes a total number of subcarriers, T denotes a symbol period of the modulated signal, and Δf denotes a frequency interval (or 1/T) between the subcarriers.

Referring to Equation 1, the typical OFDM signal may include the plurality of subcarriers (or N_{S} subcarriers, or a plurality of spectrums) arranged at preset frequency intervals (or Δf frequency intervals). In this instance, the subcarriers may have an orthogonality and thus, may not interfere with each other.

The subcarriers of the typical OFDM signal may be arranged in a symmetric structure based on a mirror point as shown in a graph 1. The mirror point may be a point that divides a frequency domain in which subcarriers are arranged and may divide a negative frequency domain and a positive frequency domain. The mirror point may be a point having a frequency of zero.

The typical OFDM signal may transmit data through a plurality of subcarriers arranged symmetrically. For example, the typical OFDM signal may transmit data at a high rate through the plurality of subcarriers including data.

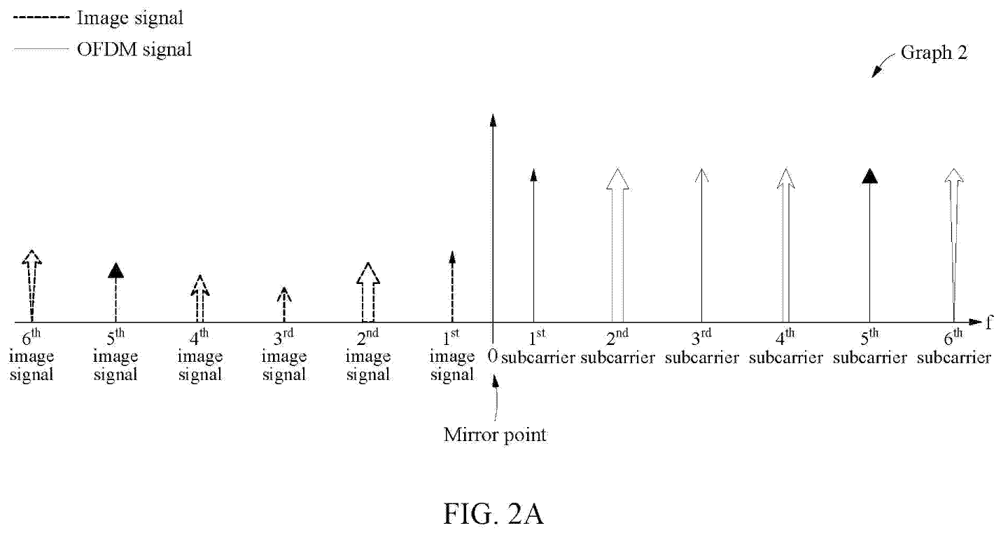

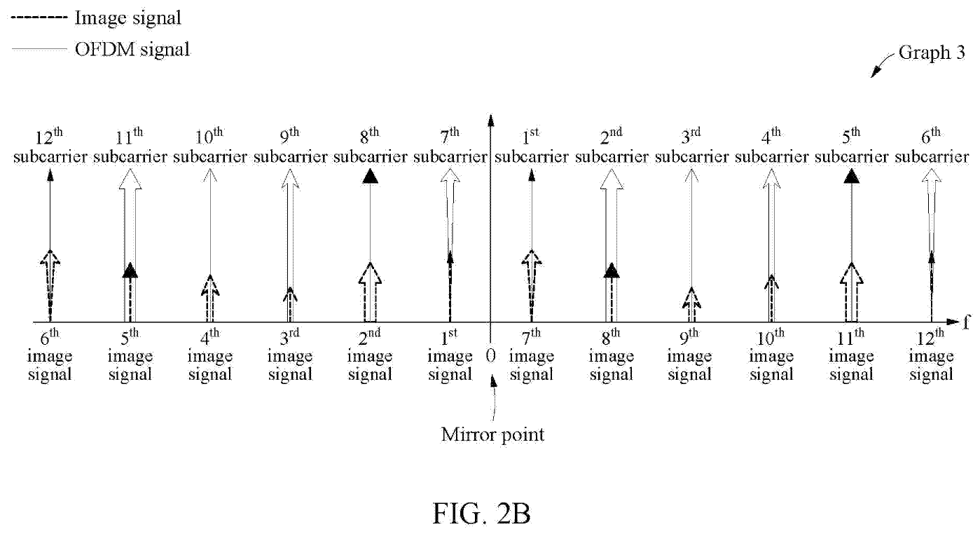

FIG. 2A illustrates an example for explaining an IQ imbalance of a typical OFDM signal and FIG. 2B illustrates another example for explaining an IQ imbalance of a typical OFDM signal. Here, I denotes “in-phase” and Q denotes “quadrature-phase.”

In a typical OFDM-based communication system, a degree, characteristics, and an effect of an I/Q imbalance may be identified based on a complex spectrum of I+jQ. An I/Q imbalance error may generate an image signal (or mirror image signal) corresponding to subcarriers. The image signal generated by the I/Q imbalance error may have different magnitudes based on a frequency in a broadband frequency range. The broadband frequency range may be a frequency range of 100 megahertz (MHz) or more including a terahertz (THz) frequency band.

As illustrated in FIGS. 2A and 2B, the image signal may be generated in a frequency domain symmetrical to a frequency domain in which the subcarriers are arranged.

Referring to FIG. 2A, when a first subcarrier to a sixth subcarrier are arranged in a positive frequency domain, the first image signal through a sixth image signal may be generated in a negative frequency domain symmetrical to a frequency domain in which subcarriers are arranged based on the mirror point as shown in a graph 2.

For example, the first image signal may be generated in a position spaced apart by −Δt based on the mirror point by the first subcarrier arranged at a position spaced apart by Δf based on the mirror point. The second image signal may be generated in a position spaced apart by −2X^{Δf} based on the mirror point by the second subcarrier arranged at a position spaced apart by 2X^{Δf} based on the mirror point. The third image signal may be generated in a position spaced apart by −3X^{Δf} based on the mirror point by the third subcarrier arranged at a position spaced apart by 3X^{Δf} based on the mirror point. The fourth image signal may be generated in a position spaced apart by −4X^{Δf} based on the mirror point by the fourth subcarrier arranged at a position spaced apart by 4X^{Δf} based on the mirror point. The fifth image signal may be generated in a position spaced apart by −5X^{Δf} based on the mirror point by the fifth subcarrier arranged at a position spaced apart by 5X^{Δf} based on the mirror point. The sixth image signal may be generated in a position spaced apart by −6X^{Δf} based on the mirror point by the sixth subcarrier arranged at a position spaced apart by 6X^{Δf} based on the mirror point.

Referring to FIG. 2B, an image signal generated in each frequency domain may cause interferences in subcarriers arranged in each frequency domain as shown in a graph 3. In this case, a signal-to-noise ratio (SNR) for subcarriers may be deteriorated. That is, each subcarrier may be interfered with by an image signal generated by a subcarrier corresponding to each subcarrier based on the mirror point.

For example, the first subcarrier may be interfered with by a seventh image signal generated by a seventh subcarrier. The second subcarrier may be interfered with by an eighth image signal generated by an eighth subcarrier. The third subcarrier may be interfered with by a ninth image signal generated by a ninth subcarrier. The fourth subcarrier may be interfered with by a tenth image signal generated by a tenth subcarrier. The fifth subcarrier may be interfered with by an eleventh image signal generated by an eleventh subcarrier. The sixth subcarrier may be interfered with by a twelfth image signal generated by a twelfth subcarrier. The seventh subcarrier may be interfered with by the first image signal generated by the first subcarrier. The eighth subcarrier may be interfered with by the second image signal generated by the second subcarrier. The ninth subcarrier may be interfered with by the third image signal generated by the third subcarrier. The tenth subcarrier may be interfered with by the fourth image signal generated by the fourth subcarrier. The eleventh subcarrier may be interfered with by the fifth image signal generated by the fifth subcarrier. The twelfth subcarrier may be interfered with by the sixth image signal generated by the sixth subcarrier.

As such, in the typical OFDM signal, an I/Q imbalance error may occur due to an image signal by each subcarrier in the broadband, which may lead to a degradation in SNR performance.

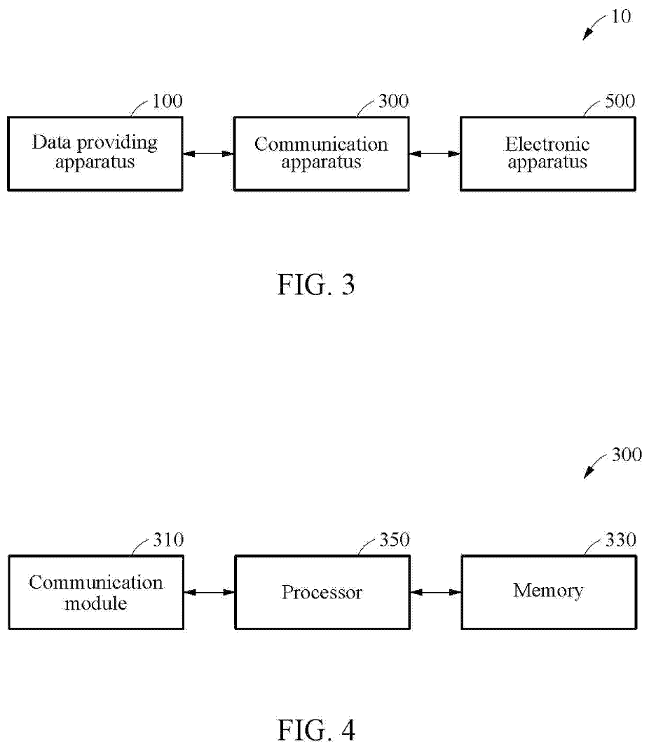

FIG. 3 is a block diagram illustrating a communication system according to an example embodiment.

A communication system 10 may include a data providing apparatus 100 and a communication apparatus 300.

The data providing apparatus 100 may transmit data to be transmitted to the communication apparatus 300. The data to be transmitted may be a data string (symbol string) input in series.

The communication apparatus 300 may perform communication based on an OFDM communication scheme using a plurality of subcarriers of a frequency domain among a plurality of subcarriers arranged asymmetrically or a plurality of subcarriers arranged symmetrically.

For example, the communication apparatus 300 may convert data transmitted from the data providing apparatus 100 into a plurality of data in parallel and include each of the plurality of data in each of the plurality of subcarriers described above. The communication apparatus 300 may perform the communication based on the OFDM communication scheme, thereby transmitting the plurality of subcarriers including the data to an electronic apparatus 500.

Through this, the communication apparatus 300 may overcome an I/Q imbalance which is difficult to be overcome in a broadband.

Even if an I/Q imbalance error with a deviation according to a frequency occurs, the communication apparatus 300 may prevent the I/Q imbalance error from affecting an SNR performance.

The communication apparatus 300 may not require an additional algorithm and/or apparatus for compensating for the I/Q imbalance to improve a degree of degradation in the SNR performance due to the I/Q imbalance.

The electronic apparatus 500 may be various devices such as a personal computer (PC), a data server, a portable electronic device, or the like. The portable electronic device may be implemented as, for example, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, and a smart device. The smart device may be implemented as a smart watch or a smart band.

FIG. 4 is a block diagram illustrating the communication apparatus of FIG. 3.

The communication apparatus 300 may include a communication module 310, a memory 330, and a processor 350.

The communication module 310 may communicate with the data providing apparatus 100 and an electronic apparatus.

The memory 330 may store instructions (or programs) to be executed by the processor 350. For example, the instructions may include instructions for executing an operation of processor 350 and/or an operation of each component of the processor 350.

The processor 350 may process data stored in the memory 330. The processor 350 may execute computer-readable codes (e.g., software) stored in the memory 330 and instructions induced by the processor 350.

The processor 350 may be a hardware-implemented data processing device having a circuit with a physical structure to perform desired operations. For example, the desired operations include codes or instructions included in a program.

The hardware-implemented data processing device includes a microprocessor, a central processing unit (CPU), a processor core, a multi-core processor, a multiprocessor, an application-specific integrated circuit (ASIC), and a field programmable gate array (FPGA).

The processor 350 may control an overall operation of the communication apparatus 300. For example, the processor 350 may control an operation of each component (e.g., 310 and 330) of the communication apparatus 300.

The processor 350 may arrange first subcarriers of a first frequency domain and second subcarriers of a second frequency domain based on the mirror point. The first frequency domain and the second frequency domain may be different frequency domains and correspond to each other based on the mirror point. The first frequency domain may be an entire domain of a positive frequency, which is a positive frequency domain. The second frequency domain is an entire domain of a negative frequency, which is a negative frequency domain. The first subcarriers may be arranged in the first frequency domain. The second subcarriers may be arranged in the second frequency domain.

As an example, the processor 350 may asymmetrically arrange the first subcarriers and the second subcarriers based on the mirror point.

Specifically, the processor 350 may arrange the first subcarriers in the first frequency domain at a first frequency interval. The first subcarriers may be arranged to be spaced apart from each other at the first frequency interval from the mirror point.

The processor 350 may arrange the second subcarriers in the second frequency domain based on positions of the first subcarriers such that the second subcarriers do not correspond to the first subcarriers. The second subcarriers may not correspond to (or overlap) the first subcarriers based on the mirror point.

As described above, although the processor 350 arranges the first subcarriers and then arrange the second subcarriers not to correspond to the first subcarriers, embodiments are not limited thereto. For example, the processor 350 may arrange the second subcarriers in the second frequency domain at the first frequency interval, and then arrange the first subcarriers in the first frequency domain based on positions of the second subcarriers such that the first subcarriers do not correspond to the second subcarriers.

As another example, the processor 350 may symmetrically arrange the first subcarriers and the second subcarriers based on the mirror point.

Specifically, the processor 350 may arrange the first subcarriers in the first frequency domain at a second frequency interval. The first subcarriers may be arranged to be spaced apart from each other at the second frequency interval from the mirror point. In this example, the processor 350 may perform communication based on the OFDM communication scheme using one of the first subcarriers and the second subcarriers. The processor 350 may not use a DC subcarrier having a frequency of zero for the communication to avoid a symmetric image signal due to an I/Q imbalance.

When the first subcarriers and the second subcarriers are arranged asymmetrically, the processor 350 may perform the communication using the first subcarriers and the second subcarriers or using the first subcarriers or the second subcarriers.

When the first subcarriers and the second subcarriers are used, the processor 350 may perform the communication by including parallel-converted data to each of the first subcarriers and the second subcarriers.

When the first subcarriers or the second subcarriers are used, the processor 350 may perform the communication by including parallel-converted data to each of the first subcarriers or each of the second subcarriers.

When the first subcarriers and the second subcarriers are arranged symmetrically, the processor 350 may perform the communication using the first subcarriers or the second subcarriers. For example, the processor 350 may perform the communication by including parallel-converted data to each of the first subcarriers or each of the second subcarriers.

That is, the processor 350 may perform the communication using the asymmetrically arranged first and second subcarriers or using one of the symmetrically arranged first and second subcarriers, thereby preventing image signals generated by the first and second subcarriers from causing interferences between the first and second subcarriers.

When the subcarriers are arranged asymmetrically, a first image signal by the first subcarriers may be generated between the second subcarriers. A second image signal by the second subcarriers may be generated between the first subcarriers. As such, the first and second image signals may not cause interferences between the first and second subcarriers and thus, may not affect an OFDM signal to be transmitted.

When the first subcarriers of the positive frequency domain are used among the symmetrically arranged first and second subcarriers, a third image signal by the first subcarriers may be generated in the negative frequency domain. As such, the third image signal may not cause interferences in the first subcarriers and thus, may not affect an OFDM signal to be transmitted.

When the second subcarriers of the negative frequency domain are used among the symmetrically arranged first and second subcarriers, a fourth image signal by the second subcarriers may be generated in the positive frequency domain. As such, the fourth image signal may not cause interferences in the second subcarriers and thus, may not affect an OFDM signal to be transmitted.

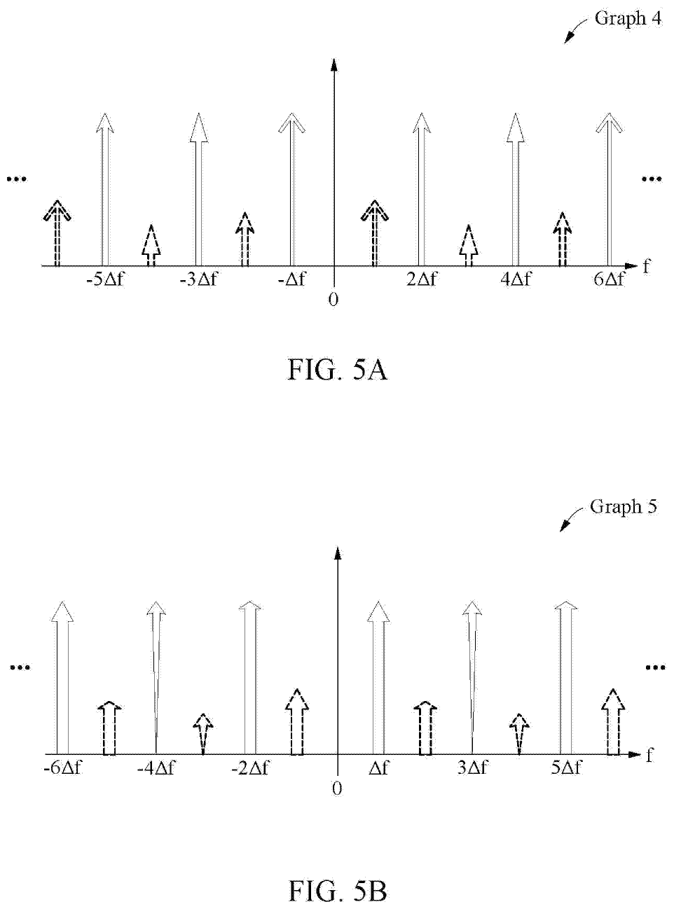

FIG. 5A illustrates an example for explaining an OFDM signal of an asymmetric structure and FIG. 5B illustrates another example for explaining an OFDM signal of an asymmetric structure. Hereinafter, an OFDM signal of an asymmetric structure may also be referred to as an “asymmetric OFDM signal.”

The asymmetric OFDM signal as shown in FIGS. 5A and 5B may include a plurality of subcarriers (or a plurality of frequency spectra) arranged asymmetrically so as not to be affected by an I/Q imbalance in a broadband.

Referring to FIG. 5A, as shown in a graph 4, a plurality of subcarriers arranged asymmetrically may be arranged at an even-numbered frequency among frequencies (or positions in which subcarriers are to be arranged) spaced apart by an interval Δ^{f} in a positive frequency domain. The plurality of subcarriers arranged at the even-numbered frequency may be spaced apart by intervals 2X^{Δf}, 4X^{Δf}, 6X^{Δf}, 8X^{Δf}, . . . , N_{S/2-2} based on a mirror point.

The plurality of subcarriers arranged at the even-numbered frequency of the positive frequency domain may be represented as shown in Equation 2.

$$k = 2 n , for k > 0 \\ s ( t ) = {\sum }_{n = 1}^{\frac{{N}_{s}}{4} - 1} {d}_{2 n + \frac{{N}_{s}}{2}} \cdot exp ( j 2 π \cdot 2 n Δ f \cdot t ) for n > 0 \qquad [ Equation 2 ]$$

In Equation 2, k denotes that the plurality of subcarriers is arranged at an even-numbered frequency and n denotes an order of the plurality of subcarriers. Referring to Equation 2, if k is 2ⁿ, the plurality of subcarriers may be arranged at the even-numbered frequency.

The plurality of subcarriers arranged asymmetrically may be arranged at an odd-numbered frequency among frequencies spaced apart by intervals −Δf in a negative frequency domain. The plurality of subcarriers arranged at the odd-numbered frequency may be spaced apart by intervals—N^{S/2+1}, . . . , −7X^{Δf}, −5X^{Δf}, −3X^{Δf}, and −1X^{Δf} based on the mirror point.

The plurality of subcarriers arranged at the odd-numbered frequency of the negative frequency domain may be represented as shown in Equation 3.

$$k = 2 n + 1 , for k < 0 \\ s ( t ) = {\sum }_{n = - \frac{{N}_{s}}{4}}^{- 1} {d}_{( 2 n + 1 ) + \frac{{N}_{s}}{2}} \cdot exp ( j 2 π \cdot ( 2 n + 1 ) Δ f \cdot t ) for n < 0 \qquad [ Equation 3 ]$$

Referring to Equation 3, if k is 2ⁿ+1, the plurality of subcarriers may be arranged at the odd-numbered frequency.

The plurality of subcarriers arranged at the even-numbered frequency of the positive frequency domain may generate an image signal at the even-numbered frequency of the negative frequency domain. The plurality of subcarriers arranged at the odd-numbered frequency of the negative frequency domain may generate an image signal at the odd-numbered frequency of the positive frequency domain.

Through this, the subcarriers and the image signal may not correspond to (or overlap) each other, may maintain an orthogonality so as not to interfere with each other, and may not affect the SNR performance.

The above description is given of the plurality of subcarriers of the asymmetric structure arranged at the even-numbered frequency in the positive frequency domain and arranged at the odd-numbered frequency in the negative frequency domain. However, embodiments are not limited thereto. For example, as shown in a graph 5, the plurality of subcarriers of the asymmetric structure may be arranged at the odd-numbered frequency in the positive frequency domain and arranged at the even-numbered frequency in the negative frequency domain.

The plurality of subcarriers arranged at the odd-numbered frequency of the positive frequency domain may be represented using Equation 4. The plurality of subcarriers arranged at the odd-numbered frequency may be spaced apart by intervals 1X^{Δf}, 3X^{Δf}, 5X^{Δf}, . . . , N_{S/2-1} based on the mirror point.

$$k = 2 n - 1 , for k > 0 \\ s ( t ) = {\sum }_{n = 1}^{\frac{{N}_{s}}{4}} {d}_{( 2 n - 1 ) + \frac{{N}_{s}}{2}} \cdot exp ( j 2 π \cdot ( 2 n - 1 ) Δ f \cdot t ) for n > 0 \qquad [ Equation 4 ]$$

The plurality of subcarriers arranged at the even-numbered frequency of the negative frequency domain may be represented using Equation 5. The plurality of subcarriers arranged at the even-numbered frequency may be spaced apart by intervals—N_{S/2}, −6X^{Δf}, −4X^{Δf}, and −2X^{Δf} based on the mirror point.

$$k = 2 n , for k < 0 \\ s ( t ) = {\sum }_{n = - \frac{{N}_{s}}{4}}^{- 1} {d}_{2 n + \frac{{N}_{s}}{2}} \cdot exp ( j 2 π \cdot 2 n Δ f \cdot t ) for n < 0 \qquad [ Equation 5 ]$$

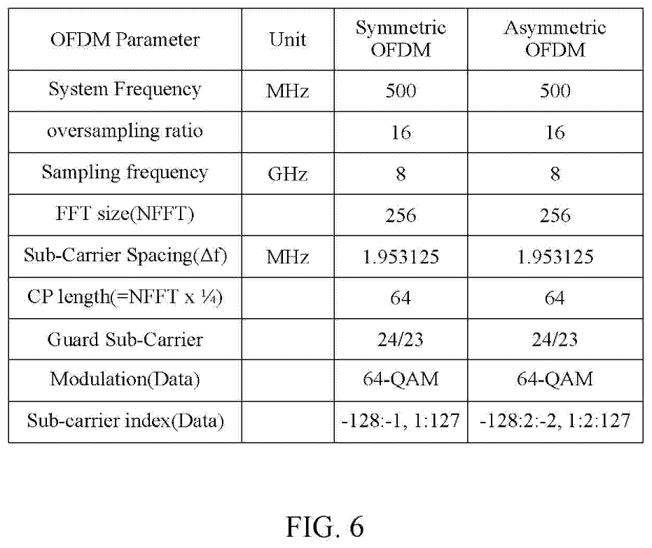

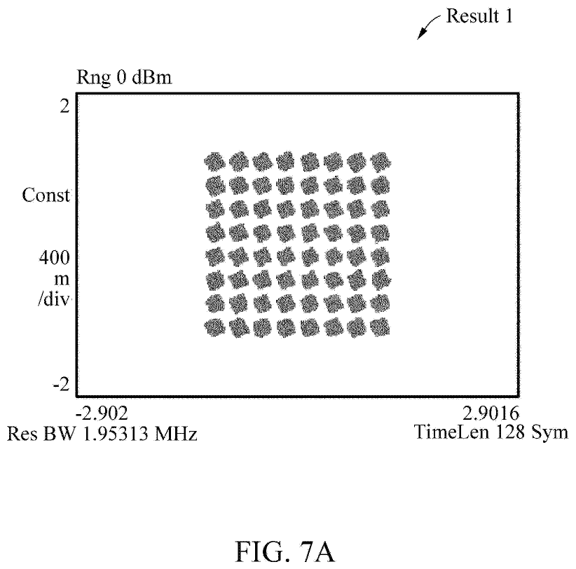

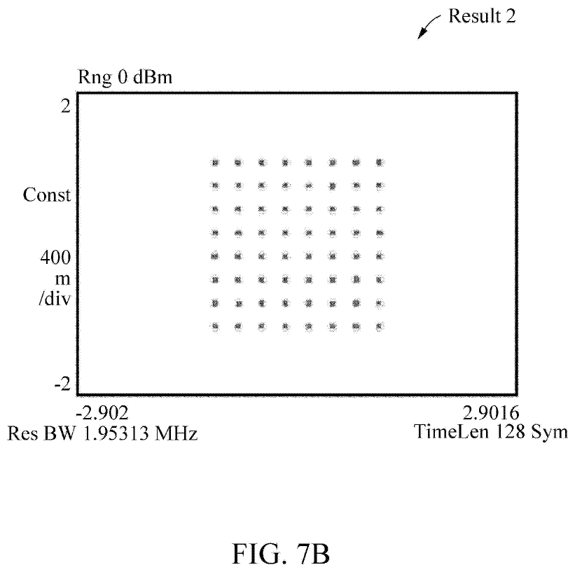

FIG. 6 illustrates a standard of a typical OFDM signal and a standard of an OFDM signal of an asymmetric structure, FIG. 7A illustrates a constellation of a typical OFDM signal based on the standard of FIG. 6, and FIG. 7B illustrates a constellation of an OFDM signal of an asymmetric structure based on the standard of FIG. 6.

Referring to FIG. 7A, when an I/Q imbalance factor and the standard of the typical OFDM signal of FIG. 6 are applied to a typical OFDM signal, it can be known from the I/Q constellation of the typical OFDM signal that an SNR performance is not good as shown in a result 1. The I/Q imbalance factor may have an I/Q phase error of 3 degrees and have an I/Q magnitude error of 1 decibel (dB). In this example, an error vector magnitude (EVM) measured in the typical OFDM signal may be −23.9 dB, which is a significantly damaged result than before the I/Q imbalance factor is applied. The EVM may be an index that indicates the SNR performance. The SNR performance may be higher as a value of the EVM is smaller. Also, the SNR performance may be less as a value of the EVM is greater.

Referring to FIG. 7B, when the above-described I/Q imbalance factor and the standard of the OFDM signal of the asymmetric structure of FIG. 6 are applied to an OFDM signal of an asymmetric structure, it can be known from the I/Q constellation of the OFDM signal of the asymmetric structure that an SNR performance is good as shown in a result 2. In this example, an EVM measured in the OFDM signal of the asymmetric may be −47.37 dB, which is the same performance as before the I/Q imbalance factor is applied.

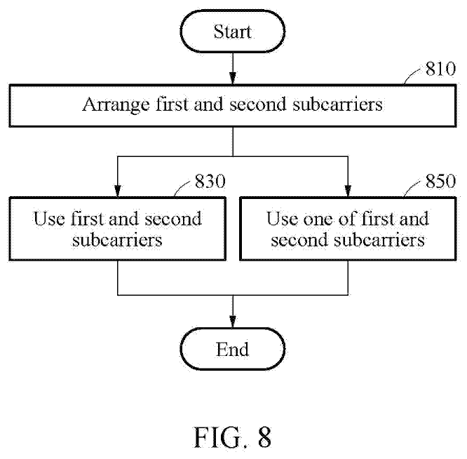

FIG. 8 is a flowchart illustrating an operation of the communication apparatus of FIG. 3.

In operation 810, the processor 350 may symmetrically arrange or asymmetrically arrange first subcarriers of a first frequency domain and second subcarriers of a second frequency domain based on a mirror point.

When the first subcarriers and the second subcarriers are arranged asymmetrically, in operation 830, the processor 350 may perform communication based on an OFDM communication scheme using at least one of the first subcarriers and the second subcarriers.

When the first subcarriers and the second subcarriers are symmetrically arranged, in operation 850, the processor 350 may perform communication based on the OFDM communication scheme using one of the first subcarriers and the second subcarriers.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described hardware devices may be configured to act as one or more software modules in order to perform the operations of the above-described example embodiments, or vice versa.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A communication method comprising:
arranging first subcarriers of a first frequency domain and second subcarriers of a second frequency domain based on a mirror point; and
performing communication based on an orthogonal frequency-division multiplexing (OFDM) communication scheme using at least one of the first subcarriers and the second subcarriers.

2. The communication method of claim 1, wherein the mirror point is a point that divides the first frequency domain and the second frequency domain and has a frequency of zero.

3. The communication method of claim 2, wherein the first frequency domain and the second frequency domain are different frequency domains and correspond to each other based on the mirror point.

4. The communication method of claim 3, wherein:
the first frequency domain is an entire domain of a positive frequency, and
the second frequency domain is an entire domain of a negative frequency.

5. The communication method of claim 1, wherein the arranging comprises:
asymmetrically arranging the first subcarriers and the second subcarriers based on the mirror point.

6. The communication method of claim 5, wherein the asymmetrically arranging comprises:
arranging the first subcarriers in the first frequency domain at a first frequency interval; and
arranging the second subcarriers in the second frequency domain based on positions of the first subcarriers such that the second subcarriers do not correspond to the first subcarriers.

7. The communication method of claim 1, wherein the performing comprises:
performing the communication using the first subcarriers and the second subcarriers when the first subcarriers and the second subcarriers are arranged asymmetrically.

8. The communication method of claim 1, wherein the performing comprises:
performing the communication using the first subcarriers or the second subcarriers when the first subcarriers and the second subcarriers are arranged symmetrically.

9. A communication apparatus comprising:
a memory comprising instructions; and
a processor configured to execute the instructions,
wherein the processor is configured to arrange first subcarriers of a first frequency domain and second subcarriers of a second frequency domain based on a mirror point and perform communication based on an orthogonal frequency-division multiplexing (OFDM) communication scheme using at least one of the first subcarriers and the second subcarriers.

10. The communication apparatus of claim 9, wherein the mirror point is a point that divides the first frequency domain and the second frequency domain and has a frequency of zero.

11. The communication apparatus of claim 10, wherein the first frequency domain and the second frequency domain are different frequency domains and correspond to each other based on the mirror point.

12. The communication apparatus of claim 11, wherein:
the first frequency domain is an entire domain of a positive frequency, and
the second frequency domain is an entire domain of a negative frequency.

13. The communication apparatus of claim 9, wherein the processor is configured to asymmetrically arrange the first subcarriers and the second subcarriers based on the mirror point.

14. The communication apparatus of claim 13, wherein the processor is configured to arrange the first subcarriers in the first frequency domain at a first frequency interval and arrange the second subcarriers in the second frequency domain based on positions of the first subcarriers such that the second subcarriers do not correspond to the first subcarriers.

15. The communication apparatus of claim 9, wherein the processor is configured to perform the communication using the first subcarriers and the second subcarriers when the first subcarriers and the second subcarriers are arranged asymmetrically.

16. The communication apparatus of claim 9, wherein the processor is configured to perform the communication using the first subcarriers or the second subcarriers when the first subcarriers and the second subcarriers are arranged symmetrically.
